(19) United States
(12) Patent Application Publication
(10) Pub. No.: US 2020/0334510 A1
(43) Pub. Date: Oct. 22, 2020

(54) RFID CHIP PROTECTING METHOD AND APPARATUS

(71) Applicant: SHENZHEN LEADERCOLOR SMART CARD CO., LTD, SHENZHEN CITY (CN)

(72) Inventor: WENCHANG HU, SHENZHEN CITY (CN)

(21) Appl. No.: 16/506,182

(22) Filed: Jul. 9, 2019

(30) Foreign Application Priority Data
Apr. 22, 2019 (CN) 201910321245.7

(51) Int. Cl. G06K 19/077

(52) U.S. Cl. CPC G06K 19/0776; G06K 19/07773

(57) ABSTRACT

Some embodiments of the present disclosure provide an RFID chip protecting method and apparatus. According to an embodiment, the RFID chip protecting method includes the steps of: preparing an RFID chip, adhering a first side face of the RFID chip onto a first side face of a double-sided adhesive, and adhering a second side face of the double-sided adhesive to a release material. According to another embodiment, the RFID chip includes a transparent film, an antenna, and a chip. The chip and the antenna are connected by a conductive adhesive, and are located on the transparent film. The first side face of the RFID chip is a surface including the transparent film, the antenna, and the chip.

### CROSS REFERENCE TO RELATED APPLICATIONS

This application claims priority to Chinese application number 20191032124-5.7 filed on Apr. 22, 2019, the disclosure of which is incorporated by reference herein in its entirety.

### FIELD OF THE DISCLOSURE

The disclosure relates generally to the field of RFID chip protection. More specifically, the disclosure relates to the field of an RFID chip protecting method and apparatus.

### BACKGROUND

In an RFID chip, an antenna, and a chip are usually mutually connected generally by using a conductive adhesive. The chip and the antenna are connected merely by the conductive adhesive with a very small area, so the joints are very easy to fall off caused by bending, striking and high temperature. Therefore, such antenna has limitations in use.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, an RFID chip protecting method includes the following steps. (1) Preparing an RFID chip. The RFID chip includes a transparent film, an antenna, and a chip. The chip and the antenna are connected by a conductive adhesive, and are located on the transparent film. (2) Adhering a first side face of the RFID chip onto a first side face of a double-sided adhesive. The first side face of the RFID chip is a surface including the transparent film, the antenna, and the chip. (3) Adhering a second side face of the double-sided adhesive to a release material.

Optionally, the thickness of the double-sided adhesive is greater than the thickness of the RFID chip.

Optionally, the release material includes a release paper or a release film.

In other embodiments, an RFID chip protecting apparatus prepared by the above-described RFID chip protecting method includes an RFID chip layer, a double-sided adhesive layer, and a release material layer sequentially connected. The side including a transparent film, an antenna, and a chip, of the RFID chip layer is connected with the double-sided adhesive layer.

In further embodiments, an RFID chip protecting method includes the following steps. (1) Preparing an RFID chip. The RFID chip includes a transparent film, an antenna, and a chip. The chip and the antenna are connected by a conductive adhesive, and are located on the transparent film. (2) Adhering a first side face and a second side face of the RFID chip onto a side face of a double-sided adhesive. The first side face of the RFID chip is a surface including the transparent film, the antenna, and the chip. (3) Adhering another side face of the double-sided adhesive to a release material.

Optionally, the thickness of the double-sided adhesive is greater than the thickness of the RFID chip.

Optionally, the release material includes a release paper or a release film.

In some embodiments, an RFID chip protecting apparatus prepared by the above-described RFID chip protecting method includes: a first release material layer, a first double-sided adhesive layer, an RFID chip layer, a second double-sided adhesive layer, and a second release material layer sequentially connected.

In other embodiments, the present disclosure provides an RFID chip protecting method including the following steps. (1) Preparing an RFID chip. The RFID chip includes a transparent film, an antenna, and a chip. The chip and the antenna are connected by a conductive adhesive, and are located on the transparent film. (2) Adhering a first side face of the RFID chip onto a first side face of a double-sided adhesive. The first side face of the RFID chip is a surface including the transparent film, the antenna, and the chip. (3) Adhering a second side face of the double-sided adhesive to a release material. The double-sided adhesive has a certain thickness and can coat a protrusion part of the chip in order to integrate the chip and the antenna to form a whole body.

According to an embodiment, an RFID chip protecting apparatus includes an RFID chip layer, a double-sided adhesive layer, and a release material layer. The RFID chip layer, the double-sided adhesive layer, and the release material layer are sequentially connected. One side of the double-sided adhesive layer further includes a transparent film, an antenna, and a chip. This side of the double-sided adhesive layer is connected with the RFID chip layer.

According to another embodiment, an RFID chip protecting apparatus includes a first release material layer, a first double-sided adhesive layer, an RFID chip layer, a second double-sided adhesive layer, and a second release material layer. The first release material layer, the first double-sided adhesive layer, the RFID chip layer, the second double-sided adhesive layer, and the second release material layer are sequentially connected.

### BRIEF DESCRIPTION OF THE DRAWINGS

FIG. 1 is a flowchart of embodiment 1 of an RFID chip protecting method.

FIG. 2 is a schematic structural diagram of embodiment 1 of an RFID chip protecting apparatus.

FIG. 3 is a flowchart of embodiment 2 of an RFID chip protecting method.

FIG. 4 is a schematic structural diagram of embodiment 2 of an RFID chip protecting apparatus.

### DETAILED DESCRIPTION

Some embodiments of the disclosure provide an RFID chip protecting method and apparatus, which may protect an RFID chip from outside breakage and extend a use range of the RFID chip.

The following described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

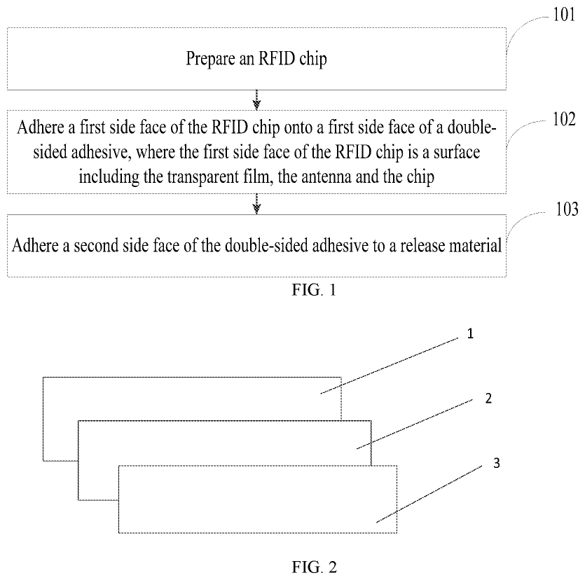

FIG. 1 is a flowchart of embodiment 1 of an RFID chip protecting method according to the disclosure. As shown in FIG. 1, the RFID chip protecting method may include the following steps.

Step 101: prepare an RFID chip. The RFID chip may include a transparent film, an antenna, and a chip. The chip and the antenna are connected by a conductive adhesive, and are located on the transparent film.

Step 102: adhere a first side face of the RFID chip onto a first side face of a double-sided adhesive. The first side face of the RFID chip is a surface including the transparent film, the antenna, and the chip, the thickness of the double-sided adhesive is greater than the thickness of the RFID chip, and the double-sided adhesive includes a substrate double-sided adhesive.

Step 103: adhere a second side face of the double-sided adhesive to a release material. The release material includes a release paper or a release film. The double-sided adhesive may have a certain thickness and may coat a protrusion part of the chip in order to integrate the chip and the antenna to form a whole body.

FIG. 2 is a schematic structural diagram of embodiment 1 of an RFID chip protecting apparatus according to the disclosure. As shown in FIG. 2, the RFID chip protecting apparatus may include an RFID chip layer 3, a double-sided adhesive layer 2, and a release material layer 1 sequentially connected. The side including a transparent film, an antenna, and a chip of the RFID chip layer is connected with the double-sided adhesive layer.

A product to be protected according to the method of the disclosure may be randomly placed in the structure interior of the other product, especially an easily bent product.

### Embodiment 2

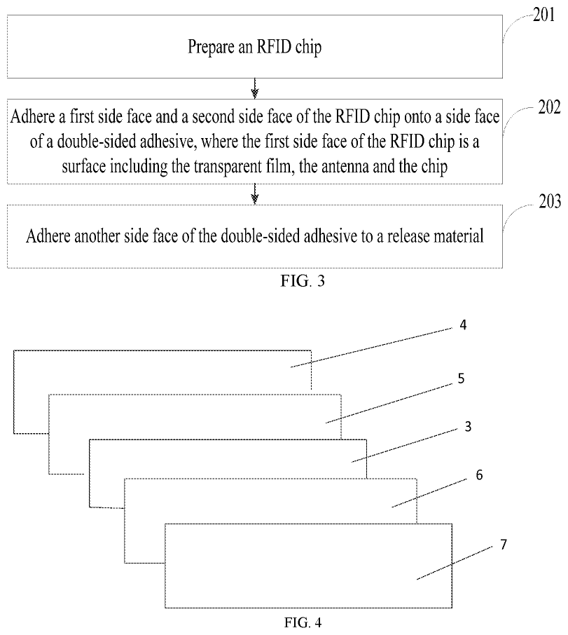

FIG. 3 is a flowchart of embodiment 2 of an RFID chip protecting method according to the disclosure. As shown in FIG. 3, the RFID chip protecting method may include the following steps.

Step 201: prepare an RFID chip. The RFID chip may include a transparent film, an antenna, and a chip. The chip and the antenna are connected by a conductive adhesive, and are located on the transparent film.

Step 202: adhere a first side face and a second side face of the RFID chip onto a side face of a double-sided adhesive. The first side face of the RFID chip is a surface including the transparent film, the antenna, and the chip, and the thickness of the double-sided adhesive is greater than the thickness of the RFID chip.

Step 203: adhere another side face of the double-sided adhesive to a release material. The release material includes a release paper or a release film.

FIG. 4 is a schematic structural diagram of embodiment 2 of an RFID chip protecting apparatus according to the disclosure. As shown in FIG. 4, the RFID chip protecting apparatus may include a first release material layer 4, a first double-sided adhesive layer 5, an RFID chip layer 3, a second double-sided adhesive layer 6, and a second release material layer 7 sequentially connected.

According to an embodiment, when the RFID chip protecting apparatus prepared according to the method of the present invention is being used, a small opening may be cut in one side of the RFID chip protecting apparatus. The release material of the small opening may be partially peeled off and adhered to the structure interior of the product. Therefore, when the product is bent, the RFID chip may automatically shrink and extend according to the bending of the product and extrusion deformation may not be easy to generate under an external force. Thus, may prevent the functions of the RFID chip in the product from being disabled by the conductive adhesive falling of the interface part of the chip and the antenna in the RFID chip.

According to another embodiment, the center of the RFID chip protecting apparatus may be perforated, the RFID chip protecting apparatus may be fixed to the interior of the product, and the size and the structure of a formed hole may be defined by the structure of the antenna. Such operating manner may be used for fixing the antenna to the structure interior of the product without deviation, at the same time solving the influence on the RFID chip due to thermal expansion and cold shrinkage, displacement, and deviation. The operating manner may be further used for achieving a purpose of protecting the RFID chip in the product to be used for a long term.

Various embodiments of the present disclosure may have one or more of the following effects. The disclosure may protect the RFID chip from the outside breakage and may extend the use range of the RFID chip. The double-sided adhesive has a certain thickness and may coat a protrusion part of the chip in order to integrate the chip and the antenna to form a whole body. When the bending occurs, a bending angle of a portion of the chip may be greatly reduced due to existence of the release material. And because the release material and the double-sided adhesive have a certain thickness, an interface part of the antenna and the chip may not easily be bent, which may prevent a tag from damage. The antenna and the chip in the RFID may be firmly connected and protected, which may reduce or prevent falling off situations from happening.

In some embodiments, the center of the RFID chip protecting apparatus may be perforated. The RFID chip protecting apparatus may be fixed to the interior of the product, and the size and the structure of a formed hole may be defined by the structure of the antenna. Such operating manner may be used for fixing the antenna to the structure interior of the product without deviation. Other embodiments of the disclosure may help to mitigate the influence on the RFID chip due to thermal expansion, cold shrinkage, displacement, and deviation. Further embodiments of the disclosure may protect a RFID chip in a product and keep it working for a long time.

Each embodiment of the present specification is described in a progressive manner, each embodiment focuses on the difference from other embodiments, and the same and similar parts between the embodiments may refer to each other. For a system disclosed in the embodiments, since it corresponds to the method disclosed in the embodiments, the description is relatively simple, and reference can be made to the method description.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. An RFID chip protecting method, comprising the steps of:
preparing an RFID chip;
adhering a first side face of the RFID chip onto a first side face of a double-sided adhesive; and
adhering a second side face of the double-sided adhesive to a release material;
wherein:
the RFID chip comprises a transparent film, an antenna, and a chip;
the chip and the antenna are connected by a conductive adhesive;
the chip and the antenna are located on the transparent film; and
the first side face of the RFID chip is a surface comprising the transparent film, the antenna, and the chip.

2. The RFID chip protecting method according to claim 1, wherein a thickness of the double-sided adhesive is greater than a thickness of the RFID chip.

3. The RFID chip protecting method according to claim 1, wherein the release material includes a release paper or a release film.

4. An RFID chip protecting method, comprising the steps of:
preparing an RFID chip;
adhering a first side face and a second side face of the RFID chip onto a side face of a double-sided adhesive; and
adhering another side face of the double-sided adhesive to a release material;
wherein:
the RFID chip comprises a transparent film, an antenna, and a chip;
the chip and the antenna are connected by a conductive adhesive;
the chip and the antenna are located on the transparent film; and
the first side face of the RFID chip is a surface comprising the transparent film, the antenna, and the chip.

5. The RFID chip protecting method according to claim 4, wherein a thickness of the double-sided adhesive is greater than a thickness of the RFID chip.

6. The RFID chip protecting method according to claim 4, wherein the release material includes a release paper or a release film.

7. An RFID chip protecting apparatus, comprising:
an RFID chip layer;
a double-sided adhesive layer; and
a release material layer sequentially connected;
wherein:
a side of the double-sided adhesive layer further comprises a transparent film, an antenna, and a chip; and
the side of the double-sided adhesive layer is connected with the RFID chip layer.

8. The RFID chip protecting apparatus according to claim 7, wherein a thickness of the double-sided adhesive is greater than a thickness of the RFID chip.

9. The RFID chip protecting apparatus according to claim 7, wherein the release material includes a release paper or a release film.
